(19) United States
(12) Patent Application Publication
(10) Pub. No.: US 2025/0204514 A1
(43) Pub. Date: Jun. 26, 2025

(54) BIRD SPIKE

(71) Applicant: Mengxiao Chen, Guangzhou (CN)

(72) Inventor: Mengxiao Chen, Guangzhou (CN)

(21) Appl. No.: 19/081,455

(22) Filed: Mar. 17, 2025

(30) Foreign Application Priority Data
Nov. 14, 2024 (CN) 202422786822.9

(51) Int. Cl. A01M 29/32

(52) U.S. Cl. CPC A01M 29/32

(57) ABSTRACT

A bird spike is provided, including a base, wherein a first mounting seat is arranged on the base; and a first spike component, wherein the first spike component is detachably connected to the first mounting seat. Through the above structure, the bird spike includes the base that is provided with the first mounting seat for mounting the first spike component, and the first spike component is detachably connected to the first mounting seat, so that the first spike component can be replaced or removed when damaged or needing to be cleaned, which prolongs a service life of the bird spike, improves the maintenance convenience of the bird spike, and reduces waste of resources.

### TECHNICAL FIELD

The present disclosure relates to the field of bird spikes, and in particular, to a bird spike.

### BACKGROUND

In the prior art, a bird spike device is widely used in places such as a building, an airport, and a farmland, to prevent birds from staying, building nests, or inhabiting, thereby avoiding the impact of bird activities on a human environment. However, the bird spike device on the existing market usually uses a fixed structure. A spike is directly mounted on a base, which lacks flexibility and detachability. Once the spike is damaged or needs to be adjusted due to environmental changes, a user can only replace the entire device, causing a waste of materials and an increase in maintenance costs.

To this end, it is necessary to provide a new type of bird spike in which a spike component can be flexibly replaced or adjusted according to a need, to prolong a service life of the bird spike, improve the maintenance convenience of the bird spike, and reduce waste of resources.

### SUMMARY

In order to overcome the shortcomings in the prior art, the present disclosure provides a bird spike in which a spike component can be mounted on a mounting seat in a detachable connection manner, so that the spike component can be flexibly replaced or adjusted according to a need, to prolong a service life of the bird spike, improve the maintenance convenience of the bird spike, and reduce waste of resources.

A technical solution used in the present disclosure to solve the technical problems is as follows:

The present disclosure provides a bird spike, including:
a base, wherein the base is provided with a first mounting seat; and
a first spike component, wherein the first spike component is detachably connected to the first mounting seat.

In an improvement of the present disclosure, the first spike component is rotatably connected to the first mounting seat; and the first spike component can rotate relative to the base to a folded or upright position.

In an improvement of the present disclosure, the first mounting seat is longitudinally provided with a first mounting hole and a second mounting hole; the first spike component includes a first needle inserted into the first mounting hole and a second needle inserted into the second mounting hole; the first mounting seat is transversely provided with a first guide slot and a second guide slot; the first guide slot is communicated to the first mounting hole; the second guide slot is communicated to the second mounting hole; the first guide slot and the second guide slot are distributed in an outwards splay manner on the first mounting seat; the first needle can tilt down or stand upright along the first guide slot; and the second needle can tilt down or stand upright along the second guide slot.

In an improvement of the present disclosure, a first mounting through slot is provided in a bottom of the first mounting seat; the first mounting through slot is communicated to the first mounting hole and the second mounting hole; the first spike component further includes a first connecting rod that connects the first needle to the second needle; and when the first needle and the second needle are respectively inserted into the first mounting hole and the second mounting hole, the first connecting rod is located in the first mounting through slot.

In an improvement of the present disclosure, the first needle is an inclined needle, and the second needle is a vertical needle.

In an improvement of the present disclosure, the bird spike further includes a second spike component; the base is further provided with a second mounting seat; the second spike component is detachably connected to the second mounting seat; the second mounting seat is longitudinally provided with a third mounting hole and a fourth mounting hole; the second spike component includes a third needle inserted into the third mounting hole and a fourth needle inserted into the fourth mounting hole; the first mounting hole and the third mounting hole are located on the same straight line; the second mounting hole and the fourth mounting hole are located on the same straight line; the third needle is a vertical needle; and the fourth needle is an inclined needle.

In an improvement of the present disclosure, the base is provided with at least two first mounting seats and second mounting seats, and the first mounting seats and the second mounting seats are arranged alternately.

In an improvement of the present disclosure, a first semicircular through hole is provided in one side of the first mounting hole away from the base, and a second semicircular through hole is provided in one side of the second mounting hole away from the base.

In an improvement of the present disclosure, the base is further provided with a fixing hole; the fixing hole is distributed between the first mounting seats; and the fixing hole is configured to fix the base to a platform through threaded connection.

In an improvement of the present disclosure, cutting grooves are provided in a bottom of the base.

In an improvement of the present disclosure, the base includes a first end portion and a second end portion which are opposite to each other; the first end portion is provided with a buckle; the second end portion is provided with a buckle slot that is matched and clamped with the buckle; the base is further provided with reinforcement seats at two transverse ends; and the first mounting seats are arranged above the reinforcement seats.

Beneficial effects of the present disclosure are as follows: The present disclosure provides a bird spike, including a base, wherein a first mounting seat is arranged on the base; and a first spike component, wherein the first spike component is detachably connected to the first mounting seat. Through the above structure, the bird spike includes the base that is provided with the first mounting seat for mounting the first spike component, and the first spike component is detachably connected to the first mounting seat, so that the first spike component can be replaced or removed when damaged or needing to be cleaned, which prolongs a service life of the bird spike, improves the maintenance convenience of the bird spike, and reduces waste of resources.

### BRIEF DESCRIPTION OF THE DRAWINGS

To describe the technical solutions in the embodiments of the present disclosure more clearly, the following briefly introduces the accompanying drawings for describing the embodiments. The accompanying drawings in the following description show merely some embodiments of the present disclosure, and a person of ordinary skill in the art may still derive other drawings from the accompanying drawings without creative efforts.

The present disclosure will be further explained below in conjunction with the accompanying drawings and embodiments.

FIG. 1 is a schematic diagram of an entire structure of the present disclosure;

FIG. 2 is a top view of a base according to the present disclosure;

FIG. 3 is an enlarged view of part A in FIG. 2;

FIG. 4 is a schematic diagram of an entire structure in another viewing angle of the present disclosure;

FIG. 5 is an exploded view of the present disclosure;

FIG. 6 is cross-sectional view cut away along a first mounting seat and a first spike component according to the present disclosure; and

FIG. 7 is a diagram of a first spike component in a folded state according to the present disclosure.

### DETAILED DESCRIPTION OF THE EMBODIMENTS

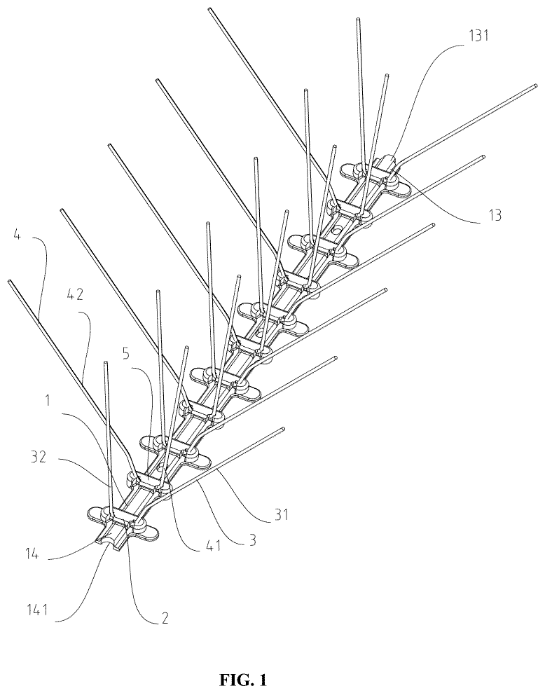

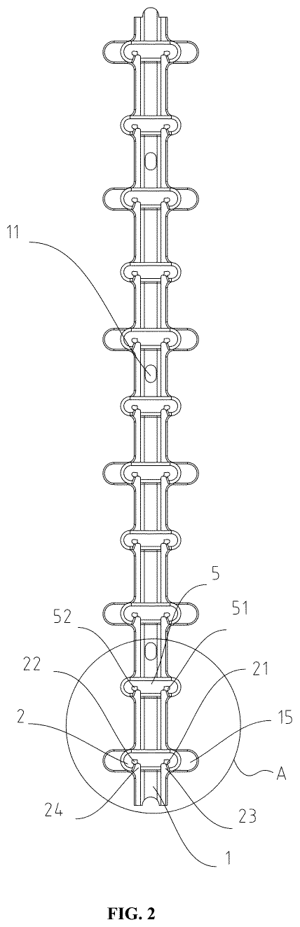

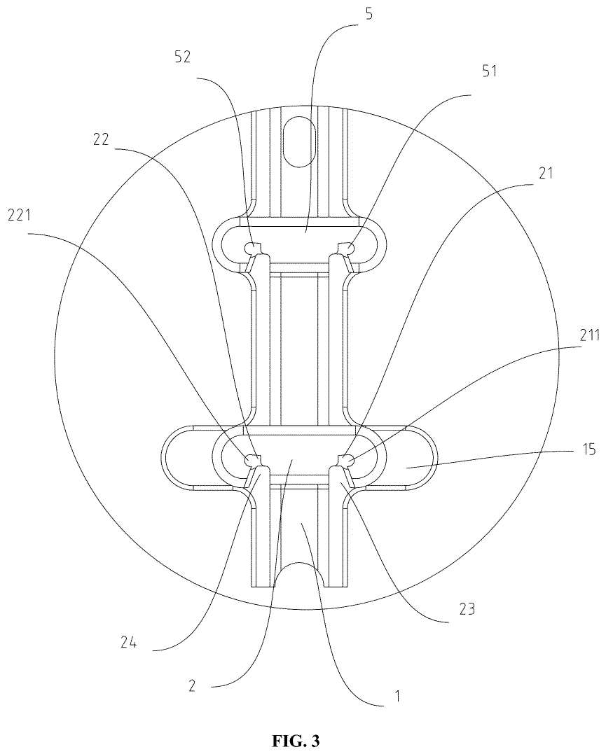

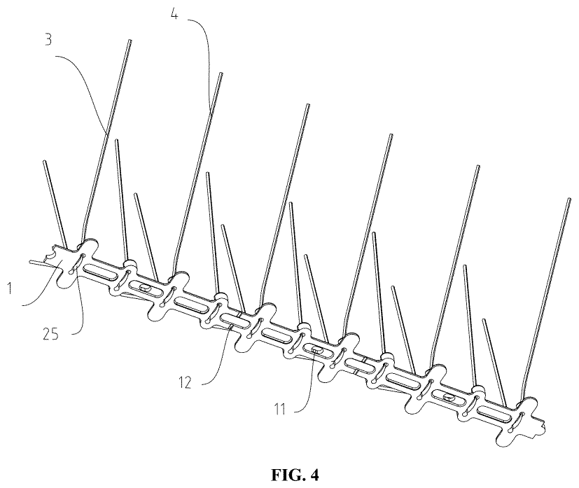

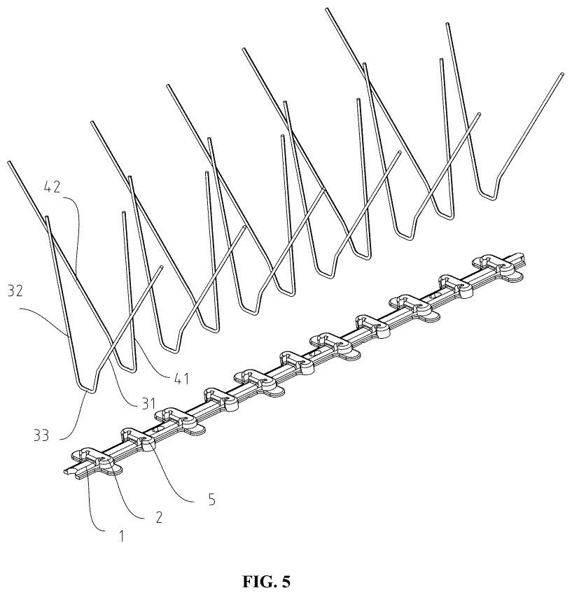

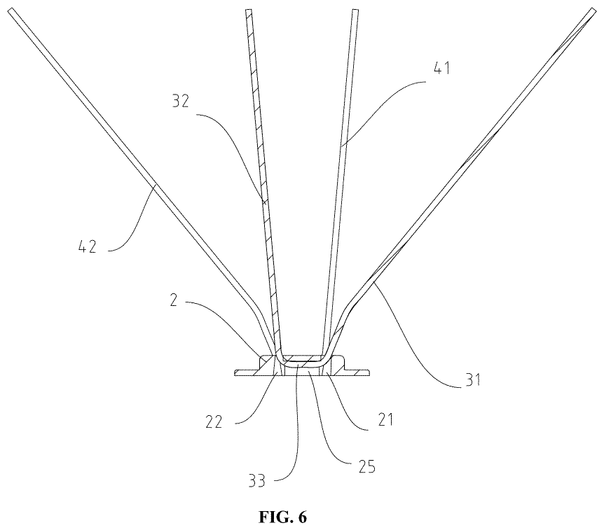

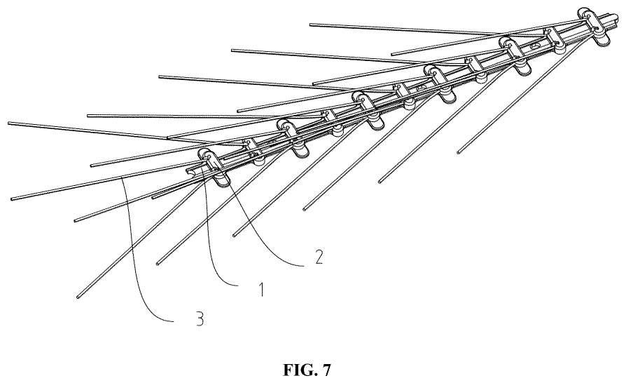

Referring to FIG. 1 to FIG. 7, a bird spike includes:
a base 1, wherein the base 1 is provided with a first mounting seat 2; and
a first spike component 3, wherein the first spike component 3 is detachably connected to the first mounting seat 2.

Through the above structure, the bird spike includes the base 1 that is provided with the first mounting seat 2 for mounting the first spike component 3, and the first spike component 3 is detachably connected to the first mounting seat 2, so that the first spike component 3 can be replaced or removed when damaged or needing to be cleaned, which prolongs a service life of the bird spike, improves the maintenance convenience of the bird spike, and reduces waste of resources.

In this embodiment, the first spike component 3 is rotatably connected to the first mounting seat 2. The first spike component 3 can rotate relative to the base 1 to a folded or upright position. Through the above structure, a folding function can reduce occupation of a space and facilitate storage and transportation.

In this embodiment, the first mounting seat 2 is longitudinally provided with a first mounting hole 21 and a second mounting hole 22. The first spike component 3 includes a first needle 31 inserted into the first mounting hole 21 and a second needle 32 inserted into the second mounting hole 22. The first mounting seat 2 is transversely provided with a first guide slot 23 and a second guide slot 24. The first guide slot 23 is communicated to the first mounting hole 21. The second guide slot 24 is communicated to the second mounting hole 22. The first guide slot 23 and the second guide slot 24 are distributed in an outwards splay manner on the first mounting seat 2. The first needle 31 can tilt down or stand upright along the first guide slot 23. The second needle 32 can tilt down or stand upright along the second guide slot 24. Through the above structure, the first guide slot 23 and the second guide slot 24 are provided, and the first guide slot 23 and the second guide slot 24 are distributed in the outwards splay manner on the first mounting seat 2, so that the first needle 31 and the second needle 32 can respectively tilt downwards along the first guide slot 23 and the second guide slot 24. The outwards splay guide slots are configured to limit a falling direction of the first spike component 3, which facilitates the first spike component 3 to tilt downwards to be folded or stand upright in a designated direction, to achieve a folding function of the needles. A user can fold and lay down the first spike component 31 when the user does not use the bird spike, to reduce occupation of a space and facilitate storage and transportation.

In this embodiment, a first mounting through slot 25 is provided in a bottom of the first mounting seat 2. The first mounting through slot 25 is communicated to the first mounting hole 21 and the second mounting hole 22. The first spike component 3 further includes a first connecting rod 33 that connects the first needle 31 to the second needle 32. When the first needle 31 and the second needle 32 are respectively inserted into the first mounting hole 21 and the second mounting hole 22, the first connecting rod 33 is located in the first mounting through slot 25. The first needle 31, the second needle 32, and the first connecting rod 33 are integrally formed. Through the above structure, to assemble the bird spike, the first needle 31 and the second needle 32 are respectively inserted into the first mounting hole 21 and the second mounting hole 22. When the first needle 31 and the second needle 32 are nearly completely inserted into the first mounting hole 21 and the second mounting hole 22, the connecting rod can be abutted against the bottom of the first mounting seat 2 and located in the first mounting through slot 25, and the first needle 31 and the second needle 32 can then lay down or stand upright respectively along the first guide slot 23 and the second guide slot 24, to achieve a bird prevention effect and storage and folding functions of the bird spike.

In this embodiment, the first needle 31 is an inclined needle, and the second needle 32 is a vertical needle. Through the above structure, the two needles are combined to provide a multi-angle protective effect, which can effectively prevent birds that approach in different angles and further enhance the bird prevention effect.

In this embodiment, the bird spike further includes a second spike component 4. The base 1 is further provided with a second mounting seat 5. The second spike component 4 is detachably connected to the second mounting seat 5. The second mounting seat 5 is longitudinally provided with a third mounting hole 51 and a fourth mounting hole 52. The second spike component 4 includes a third needle 41 inserted into the third mounting hole 51 and a fourth needle 42 inserted into the fourth mounting hole 52. The first mounting hole 21 and the third mounting hole 51 are located on the same straight line. The second mounting hole 22 and the fourth mounting hole 52 are located on the same straight line. The third needle 41 is a vertical needle. The fourth needle 42 is an inclined needle.

Further, the base 1 is provided with at least two first mounting seats 2 and second mounting seats 5, and the first mounting seats 2 and the second mounting seats 5 are arranged alternately. Through the above structure, the first mounting seats 2 and the second mounting seats 5 are arranged alternately, so that the vertical needle and the inclined needle can be arranged alternately to form a denser and more appropriate needle distribution, which enhances the overall protective effect.

In this embodiment, a first semicircular through hole 211 is provided in one side of the first mounting hole 21 away from the base 1, and a second semicircular through hole 221 is provided in one side of the second mounting hole 22 away from the base 1. Through the above structure, the first semicircular through hole 211 and the second semicircular through hole 221 are well matched with circular rods of the needles to well fix the spike component, so that the spike component is not likely to shake, which improves the stability of the bird spike.

In this embodiment, the base 1 is further provided with a fixing hole 11. The fixing hole 11 is distributed between the first mounting seats. The fixing hole 11 is configured to fix the base 1 to a platform through threaded connection. In some other embodiments, the base 1 can be fixed in different ways, such as, by an adhesive and a strap.

In this embodiment, cutting grooves 12 are provided in a bottom of the base 1. Through the above structure, since the cutting grooves 12 are provided in the bottom of the base, a user can easily cut the base 1 along the cutting grooves 12 according to an actual mounting need, and a size of the bird spike is more flexible.

In this embodiment, the base 1 includes a first end portion 13 and a second end portion 14 that are opposite to each other. The first end portion 13 is provided with a buckle 131. The second end portion 14 is provided with a buckle slot 141 that is matched and clamped with the buckle 131. A length of the base 1 is 25 cm. Through the above structure, the first end portion 13 of the base 1 is provided with the buckle 131, and the second end portion 14 is provided with the buckle slot 141 that is matched and clamped with the buckle 131. By the cooperation between the buckle 131 and the buckle slot 141, a plurality of bases 1 can be stably assembled together to prolong a desired length. It is convenient for a user to flexibly adjust the length according to an actual mounting site to meet protection requirements of different regions.

In this embodiment, the base 1 is further provided with reinforcement seats 15 at two transverse ends. The first mounting seats 2 are arranged above the reinforcement seats 15. Through the above structure, a supporting force and stability of the bird spike are improved.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. A bird spike, comprising:
a base (1), wherein the base (1) is provided with a first mounting seat (2); and
a first spike component (3), wherein the first spike component (3) is detachably connected to the first mounting seat (2);
the first spike component (3) is rotatably connected to the first mounting seat (2); and
the first spike component (3) rotates relative to the base (1) to a folded or upright position.

2. The bird spike according to claim 1, wherein the first mounting seat (2) is longitudinally provided with a first mounting hole (21) and a second mounting hole (22); the first spike component (3) comprises a first needle (31) inserted into the first mounting hole (21) and a second needle (32) inserted into the second mounting hole (22); the first mounting seat (2) is transversely provided with a first guide slot (23) and a second guide slot (24); the first guide slot (23) is communicated to the first mounting hole (21); the second guide slot (24) is communicated to the second mounting hole (22); the first guide slot (23) and the second guide slot (24) are distributed in an outwards splay manner on the first mounting seat (2); the first needle (31) tilts down or stands upright along the first guide slot (23); and the second needle (32) tilts down or stands upright along the second guide slot (24).

3. The bird spike according to claim 2, wherein a first mounting through slot (25) is provided in a bottom of the first mounting seat (2); the first mounting through slot (25) is communicated to the first mounting hole (21) and the second mounting hole (22); the first spike component (3) further comprises a first connecting rod (33) that connects the first needle (31) to the second needle (32); and when the first needle (31) and the second needle (32) are respectively inserted into the first mounting hole (21) and the second mounting hole (22), the first connecting rod (33) is located in the first mounting through slot (25).

4. The bird spike according to claim 2, wherein the first needle (31) is an inclined needle, and the second needle (32) is a vertical needle.

5. The bird spike according to claim 4, further comprising a second spike component (4), wherein the base (1) is further provided with a second mounting seat (5); the second spike component (4) is detachably connected to the second mounting seat (5); the second mounting seat (5) is longitudinally provided with a third mounting hole (51) and a fourth mounting hole (52); the second spike component (4) comprises a third needle (41) inserted into the third mounting hole (51) and a fourth needle (42) inserted into the fourth mounting hole (52); the first mounting hole (21) and the third mounting hole (51) are located on the same straight line; the second mounting hole (22) and the fourth mounting hole (52) are located on the same straight line; the third needle (41) is a vertical needle; and the fourth needle (42) is an inclined needle.

6. The bird spike according to claim 5, wherein the base (1) is provided with at least two first mounting seats (2) and second mounting seats (5), and the first mounting seats (2) and the second mounting seats (5) are arranged alternately.

7. The bird spike according to claim 2, wherein a first semicircular through hole (211) is provided in one side of the first mounting hole (21) away from the base (1), and a second semicircular through hole (221) is provided in one side of the second mounting hole (22) away from the base (1); the base (1) is further provided with a fixing hole (11); the fixing hole (11) is distributed between the first mounting seats; and the fixing hole (11) is configured to fix the base (1) to a platform through threaded connection.

8. The bird spike according to claim 1, wherein cutting grooves (12) are provided in a bottom of the base (1).

9. The bird spike according to claim 1, wherein the base (1) comprises a first end portion (13) and a second end portion (14) which are opposite to each other; the first end portion (13) is provided with a buckle (131); the second end portion (14) is provided with a buckle slot (141) that is matched and clamped with the buckle (131); the base (1) is further provided with reinforcement seats (15) at two transverse ends; and the first mounting seats (2) are arranged above the reinforcement seats (15).
